(19) United States
(12) Patent Application Publication
(10) Pub. No.: US 2007/0114179 A1
(43) Pub. Date: May 24, 2007

(54) REMOVAL OF FLUORIDE IONS FROM AQUEOUS SOLUTIONS

(76) Inventor: Timothy J. Badger, Scituate, MA (US)

Correspondence Address: WELSH & KATZ, LTD, 120 S RIVERSIDE PLAZA, 22ND FLOOR, CHICAGO, IL, 60606, US

(21) Appl. No.: 11/469,613

(22) Filed: Sep. 1, 2006

Related U.S. Application Data
(60) Provisional application No. 60/714,643, filed on Sep. 7, 2005.

(51) Int. Cl. C02F 1/42

(52) U.S. Cl. 210/683; 210/915

(57) ABSTRACT

A process for removing fluoride ions from a fluoride ion-contaminated aqueous solution and an apparatus useful for carrying out that process, both of which utilize modified alumina particles are disclosed. The modified alumina particles contain alumina complexed with iron or manganese, or both.

### CROSS-REFERENCE TO RELATED APPLICATION

This application claims benefit of provisional application Ser. No. 60/714,643 that was filed on Sep. 07, 2005.

### TECHNICAL FIELD

The present invention relates to a process for removing fluoride ions from an aqueous solution. In particular, a fluoride-containing aqueous solution is contacted with modified alumina particles that contain iron or manganese or both sorbed substantially homogeneously distributed throughout, the contact is maintained and the solution containing a reduced amount of fluoride ions is separated from the solid particles.

### BACKGROUND

Although it is widely believed that the ingestion of fluoride in water is harmless and even helpful, much research suggests otherwise. The detrimental physical effects of excessive systemic fluoride ingestion include dental fluorosis, skeletal fluorosis, and myriad other systemic effects such as kidney disease, hypersensitivity reactions, enzyme effects, genetic mutations, birth defects, and cancer to name a few.

One of the most prevalent detrimental physical effects of fluoride ingestion is dental fluorosis. Dental fluorosis is the fluoride mineralization of the tooth enamel (replacement of the hydroxyl ion by the fluoride ion). It is characterized by discolored lesions on the teeth (yellow, brown, and grey mottling), hypoplasia (subnormal growth and development of the teeth), hypocalcification (reduced calcification of the teeth), pitting of the teeth, and increased wear of the teeth. These effects are noted in children under the age of seven years when the fluoride concentration in their drinking water exceeds 1.5 milligrams per liter (mg/L: or parts per million, ppm).

Another prevalent detrimental physical effect of fluoride ingestion is skeletal fluorosis. Skeletal fluorosis is the fluoride mineralization of bone (replacement of the hydroxyapetite ion by the fluoride ion.) The symptoms of skeletal fluorosis include chronic bone pain; fusion of vertebrae; osteoporosis (decrease in bone mass with reduced density and enlarged spaces within bone producing porosity and fragility); osteosclerosis (bones become more dense and have abnormal crystalline structure); joint and ligament calcification; sensations of burning, pricking, and tingling in the limbs; muscle weakness; chronic fatigue; gastrointestinal disorders; and reduced appetite.

The effects of fluoride ingestion on the human body are not limited to the teeth and bones. As mentioned above, there are other serious detrimental physical effects as a result of the ingestion of fluoride. Some of the diseases which have been linked to fluoride ingestion are: Alzheimer's Disease/demyelinizing diseases, anemia, arthritis, breast cancer, carpal tunnel syndrome, decrease in testosterone/spermatogenesis, altered vas deferens/testicular growth, decreased dental arch, dental crowding, delayed tooth eruption, diabetes insipidus, diarrhea, Down Syndrome, early onset of puberty, eosinophilia, eye/ear/nose disorders, fever, gastro-intestinal disturbances, gingivitis, heart disorders, hypertension, hypoplasia, hypothyroidism-thyroid cancer, kidney dysfunction, osteosarcoma, low birth weight, candidiasis, multiple sclerosis, oral squamous cell carcinoma, Parkinson's Disease, seizures, slurred speech, skin irritations, ankylosing spondylitis, telangiectasia, thrombosis, ulcerative colitis, uterine cancer, vaginal bleeding, and weak pulse.

Although there are many sources of fluoride in our environment, naturally-fluoridated water is the most ubiquitous and troublesome source of fluoride ingested by humans. In fact, the majority of cases of skeletal fluorosis in the world are caused by the ingestion of naturally-fluoridated water. In developing countries such as India, China, Africa, Latin America and the Middle East, skeletal fluorosis as a result of drinking naturally fluoridated water is particularly prevalent due to the emphasis on the performance of heavy physical labor, the severe inaccessibility to adequate healthcare, and poor nutrition. Skeletal fluorosis is compounded in these situations because these persons are in a state of fasting while consuming fluoride-rich water, do not consume a cation rich diet (namely calcium), and are sometimes metabolically-challenged as well (i.e., suffer from kidney disease). It follows then, that in India, for example, more than one million people suffer from this skeletal fluorosis. Most of the victims there live in areas where the fluoride level in water is 2 ppm or above, but some cases they live in communities where the natural fluoride level in water is less than 1 ppm.

Thus, there is an urgent need for a process that will remove unwanted fluoride ions from aqueous solutions in an efficient, economical, and environmentally sound manner. It is desirable that such a process be flexible and sufficiently robust in order to address the requirements of large municipal water utilities, private wells in developed countries, and contaminated water sources in undeveloped countries. It is also desirable that a fluoride removal method is able to remove excess fluoride from water without removing all of the trace minerals that contribute to the flavor of water.

A few technologies have been described in the art to remove excess fluoride from water. These include reverse osmosis, alumina adsorption, distillation, and classic ion-exchange. Although these methods can be somewhat effective at reducing fluoride concentrations, none is as effective as that described hereinafter, and none offer the simplicity of use required for private well treatment or for less developed areas of the world where reliable electrical power is unavailable. In these situations, a “point of use” treatment is necessary or water must be transported in for use.

The modified alumina particles of the present invention are seemingly similar to the media described in U.S. Pat. No. 6,599,429 ('429), Azizian et al. However, the particles contemplated here greatly differ in structure being substantially physically homogeneous in alumina and iron whereas the medium in '429 is merely an iron coating of the alumina. In other words, the medium in '429 has an alumina core with an iron outer layer in a biphasic fashion. Secondly, the modified alumina particles contemplated here have a much higher binding affinity for fluoride ions due to their unique structure over the medium found in '429 as shown in the disclosure that follows.

### BRIEF SUMMARY OF THE INVENTION

One aspect of the present invention contemplates a process for removing fluoride ions from an aqueous solution contaminated with soluble fluoride ions; i.e., having a fluoride ion concentration in excess of about 1.5 ppm, preferably in excess of about 2 ppm and most preferably in excess of about 4 ppm. This process comprises contacting an aqueous solution contaminated with fluoride ions with modified alumina particles that comprise a complex of alumina with iron or manganese, or both. The contact is maintained for a time period sufficient for the fluoride ions to be sorbed by the modified alumina particles to form particles containing fluoride and an aqueous solution having a reduced fluoride concentration. The modified alumina particles containing fluoride are separated from the aqueous solution having a reduced fluoride concentration. It is particularly preferred that the aqueous solution having a reduced fluoride ion concentration have a fluoride ion concentration that is less than that of a contaminated aqueous solution.

In another aspect of this invention, the process utilizes modified alumina particles that are comprised of iron substantially homogeneously sorbed throughout the particles with the iron present in an amount of about 0.10 to about 0.15 molar in a gravity-settled volume of particles in deionized water.

In an alternate embodiment of this invention, the process utilizes modified alumina particles that are comprised of manganese substantially homogeneously sorbed throughout the particles with the manganese present in an amount of about 0.05 to about 0.075 molar in a gravity-settled volume of particles in deionized water.

In this invention, the pH value of the fluoride ion-contaminated aqueous solution is about 6 to about 9 and more preferably about 6.5 to about 8.6.

A still further contemplated aspect of this invention is an apparatus for use in the removal of fluoride ions from aqueous solutions by the sorbing action of modified alumina particles.

The present invention has several benefits and advantages.

One benefit is that it provides an inexpensive solid phase medium that can remove fluoride ions from aqueous solutions.

Another benefit of the invention is that a contemplated solid phase alumina-based medium containing sorbed fluoride binds those ions tightly, thereby permitting disposal of spent medium in a land fill or even in concrete without worry of leaching of the bound ions to the environment.

Still further benefits and advantages of the invention will be apparent to the worker of ordinary skill from the disclosure that follows.

### BRIEF DESCRIPTION OF THE DRAWINGS

FIG. 1 shows a schematic representation of a separation vessel useful in an embodiment of the invention.

FIG. 2 shows a schematic representation of another separation vessel useful in an embodiment of the invention.

FIG. 3 shows a schematic representation of yet another separation vessel useful in an embodiment of the invention.

FIG. 4 shows a schematic representation of separation vessels, of a type similar to that of FIG. 3, assembled in series in system made in accordance with the teachings of the invention.

FIG. 4A is a side view of the separation vessel assembly of FIG. 4.

### DETAILED DESCRIPTION OF THE INVENTION

While the present invention is susceptible of embodiment in various forms, there is shown in the drawings a number of presently preferred embodiments that are discussed in greater detail hereafter. It should be understood that the present disclosure is to be considered as an exemplification of the present invention, and is not intended to limit the invention to the specific embodiments illustrated. It should be further understood that the title of this section of this application (“Detailed Description of the Invention”) relates to a requirement of the United States Patent Office, and should not be found to limit the subject matter disclosed herein.

The present invention contemplates a process for removing fluoride ions from aqueous solutions contaminated with fluoride ions; i.e., having a fluoride ion concentration in excess of about 1.5 ppm, preferably in excess of about 2 ppm and most preferably in excess of about 4 ppm, and an apparatus useful for carrying out that process, both of which utilize modified alumina particles.

Thus, one aspect of the present invention contemplates a process for removing fluoride ions from a fluorine ion-contaminated aqueous solution that comprises contacting the contaminated fluoride ion-containing aqueous solution with modified alumina particles that comprise a complex of aluminum with iron or manganese, or both. That contact is maintained for a time period sufficient for the fluoride ions to be sorbed by the modified alumina particles to form particles containing fluoride and an aqueous solution having a reduced fluoride concentration. The modified alumina particles containing fluoride are thereafter separated from the aqueous solution having a reduced fluoride concentration.

In one aspect of this process, the modified alumina particles comprise iron substantially homogeneously sorbed throughout the particles. The iron can be present in an amount up to saturation, but are preferably present in an amount of about 0.10 to about 0.15 molar in a gravity-settled volume of particles in deionized water.

Alternatively, in another aspect of the invention, the modified alumina particles can be comprised of manganese substantially homogeneously sorbed throughout the particles with the manganese present up to a saturation amount. More preferably, the manganese is present in an amount of about 0.05 to about 0.075 molar in a gravity-settled volume of particles in deionized water.

Both types of particle can also be used together, so that a preferred amount of metal can be about 0.05 to about 0.10 molar in a gravity-settled volume of particles in deionized water.

Preferably, the pH value of the contaminated aqueous solution is about 6 to about 9, and more preferably about 6.5 to about 8.6.

Also, a contemplated process for removing fluoride ions from a fluoride ion-contaminated aqueous solution can occur in multiple stages. Such a process comprises contacting the aqueous solution with a portion of before-discussed modified alumina particles. The individual portions of particles in the sequence are comprised of the same type of particles (an), one or more different particles (a^{u}+bⁿ), or a mixture thereof (a+b)ⁿ. The individual contact so made is maintained for a time period sufficient for the fluoride ions to be sorbed by the modified alumina particles to form particles containing fluoride and an aqueous solution having a reduced fluoride concentration. The individually contacted portions of modified alumina particles containing fluoride are separated from the aqueous solution having a reduced fluoride concentration. The aqueous solution having a reduced fluoride concentration is then contacted with another portion of modified alumina particles. This contact is maintained for a time period sufficient for the fluoride ions to be sorbed by the particles to create an aqueous solution having a further reduced fluoride concentration and another portion of modified alumina particles containing fluoride. These fluoride-containing particles then are separated from the solution having a further reduced fluoride concentration. This cycle can be repeated as necessary to achieve the desired reduction in fluoride concentration in the aqueous solution.

In this multi-stage sequential process, the modified particles can be alumina-iron or alumina-manganese or a heterogeneous mixture of alumina-iron and alumina-manganese particles. Preferably, three tanks are utilized in a series. The first tank is designated as the worker column, the second or middle tank is designated as the guard column and the third or last tank in the series is designated as the polishing column. As the fluoride solution passes down and through each tank in the sequence of tank 1 to tank 2 and tank 3, the fluoride binds to the particles. As the sorbent's capacity is reduced, from the top down, fluoride begins to leach through and out to the tank next in order. The calculation of bed and tank size takes into account not only the rate of flow but the anticipated medium capacity and ultimate exhaustion. The goal is to have the effluent of tank 3 be within acceptable levels; i.e., to have the fluoride ion concentration at less than a contaminating concentration, and at the same time fully utilizing the capacity of tank 1. In conditions where a very high level of fluoride is present an additional tank [tank 4] can also be added.

In addition, this invention contemplates a particularly preferred process for removing fluoride ions from a fluoride ion-contaminated water supply that comprises the steps of contacting a fluoride ion-contaminated aqueous solution with modified alumina particles that contain iron or manganese or both sorbed substantially homogeneously distributed throughout in an amount of about 0.05 to about 0.15 molar as measured in a gravity-settled volume of particles in deionized water. The particles optionally also contain an oxidized iodine species such as periodate ion, (perbromate can also be used) and are substantially free of molecular iodine (or bromine). The contact is maintained for a time period sufficient for fluoride ions present to be sorbed by the particles to form fluoride-containing particles and an aqueous solution having a reduced amount of fluoride. The fluoride-containing particles are separated from the aqueous solution having a reduced amount of fluoride.

Preferably, in this process the pH value of the aqueous solution is as previously discussed. The aqueous solution is preferably pre-filtered before contacting with the modified alumina particles to remove substantially all solid material.

In preferred practice, it is contemplated that contact between the fluoride-containing aqueous solution and the particles be carried out in a chromatographic column or flow-through container, such as a perforated plastic or mesh pouch containing adsorption particles, e.g., a “tea bag”. A glass or plastic (e.g. polyethylene or polypropylene) column is a particularly preferred vessel for use herein and has an inlet for receiving an aqueous sample solution prior to contact of the sample solution with the particles and an outlet for the egress of water after contact with the particles.

Also, this invention relates to an apparatus for removing fluoride from an aqueous solution that is contaminated with fluoride ions that comprises a vessel having an inlet, an outlet, and a modified alumina complex in a modified-alumina-complex-containing region wherein the complex is supported and contained within the modified-alumina-complex-containing region.

This apparatus preferably comprises a vessel that includes a first flow-permitting support positioned between the outlet and modified-alumina-complex-containing region. In addition, the apparatus comprises a vessel that includes a second flow-permitting support positioned between the inlet and modified-alumina-complex-containing region.

A contemplated support vessel is typically glass or plastic such as polyethylene or polypropylene and is typically a chromatographic column or cartridge. A contemplated vessel can include one or more inlets, outlets, valves such as stopcocks and similar appendages.

One contemplated support vessel is cylindrical and has an inlet for receiving a fluid such as an aqueous solution prior to contact of the solution with the contained particles and an outlet for the egress of water after contact with the particles. When the support vessel is a glass or plastic chromatographic column or cartridge, the vessel can contain appropriate valves such as stopcocks for controlling aqueous flow, as are well-known, as well as connection joints such as Luer fittings. The inlet for receiving an aqueous liquid solution and outlet for liquid egress can be the same structure as where a beaker, flask or other vessel is used for a contemplated process, but the inlet and outlet are typically different and are separated from each other when a fluid such as air is utilized. Usually, the inlet and outlet are at opposite ends of the apparatus.

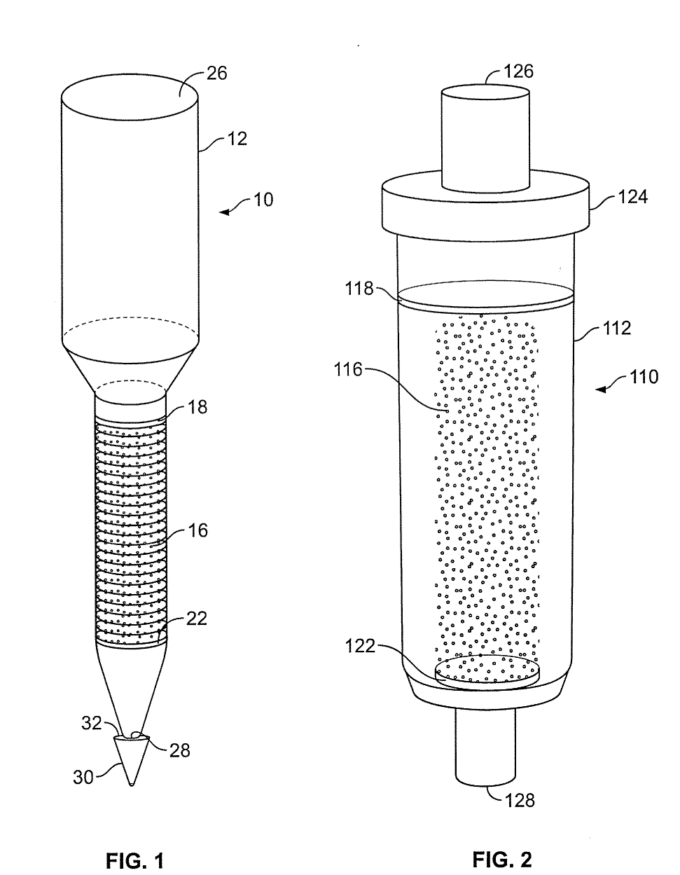

FIG. 1 provides a schematic drawing of one preferred apparatus for use in removing fluoride ions from aqueous solution. Here, the apparatus 10 is shown to include a support vessel as a column 12 having an inlet 26 and an outlet 28 for water. The outlet has an integral seal and is separable from the seal at a frangible connection 32. The apparatus 10 contains one or more flow-permitting support elements. In one embodiment, a frit 22 supports particles 16, and an upper frit 18 helps to keep the particles in place during the introduction of an influent of aqueous solution. Contemplated frits can be made of glass or plastic such as high density polyethylene (HDPE). A HDPE frit of 35-45 μm average pore size is preferred. A contemplated apparatus can also include a stopcock or other flow-regulating device (not shown) at, near or in conjunction with the outlet 28 to assist in regulating flow through the apparatus.

An above-described chromatographic column is typically offered for sale with a cap (not shown) placed into inlet 26 and snap-off (frangible) tube end 30. The particles in such a column are typically wet and equilibrated with aseptic water and can be used as part of a backpacker's kit for a hike or camping trip or the like.

FIG. 2 provides a second schematic drawing of another preferred apparatus. Here, the apparatus 110 is shown to include a support vessel as a cartridge 112 having an inlet 126 and an outlet 128 for water. A cap 124 is preferably integrally molded with the inlet 126. The outlet 128 is preferably integrally molded with the cartridge 112. The apparatus 110 contains a porous support such as a frit 122 that supports particles 116. An upper porous support such as a frit 118 helps to keep the particles in place during the introduction of an influent aqueous sample or eluting solution. A contemplated apparatus can also include a stopcock or other flow-regulating device (not shown) at, near or in conjunction with the outlet 128 to assist in regulating flow through the apparatus.

A contemplated cartridge such as a vessel of FIG. 2 is typically provided with the particles in a dry state, or wet with aseptic, fluoride ion-free water. In addition, inlet 126 and outlet 128 are preferably standard fittings such as Luer fittings that are adapted for easy connection to other standard gas and/or liquid connections. This embodiment is particularly adapted for use in a person's sink as a final filter prior to use of the water, as where potable water is delivered from a well. This embodiment containing particles is also particularly adapted for use with air as the fluid.

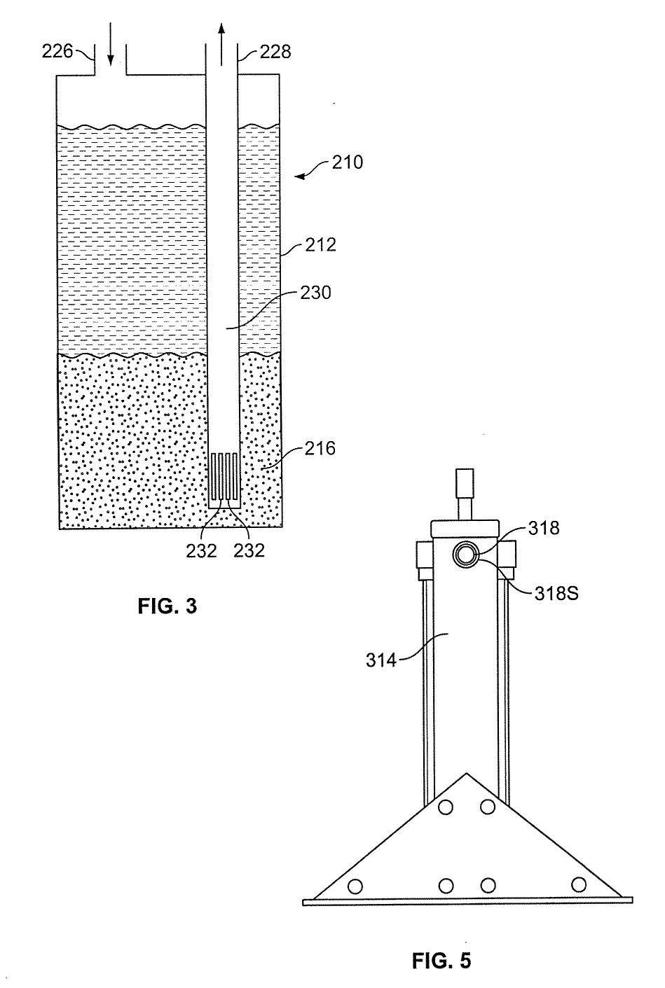

FIG. 3 illustrates a schematic diagram of yet another apparatus 210 for carrying out the present invention. The apparatus 210 includes a support vessel 212 having an inlet port 226 and an outlet port 228. The inlet and outlet ports 226, 228 are positioned on a common end of the vessel 212. This arrangement can be used where, for example, access to the entire vessel 212 is limited and attachment of connecting tubing (not shown) is facilitated by locating the ports 226, 228 near or adjacent one another.

The vessel 212 supports the particles 216 therein to a predetermined height (corresponding to a column volume) within the vessel 212. A dip pipe 230 is located within the vessel 212 in flow communication with the outlet port 228. The dip pipe 230 provides a path for discharging treated (e.g., aseptic) water from the vessel 212.

Slits 232 or other openings are formed in the dip pipe 230 to provide a flow path from the vessel 212 to the interior of the pipe 230 and thus the vessel outlet 228. The slits 232 or openings are sized accordingly to prevent the loss of particles 216 from the vessel 212. As with the previously described embodiments, a support, such as frit (not shown) can be placed over the particles 216 to maintain the particles 216 in place in the vessel 212.

As will be readily understood from a study of FIG. 3, water is supplied to the vessel 212 through the inlet port 226. The water “fills” the vessel 212 to an operational level. Treated water is drawn from the outlet 228 through the dip pipe 230. The water flow through the dip pipe 230 can only enter the pipe by flowing through the particles 216. Thus, a compact, readily connected apparatus 210 by which to treat water is provided.

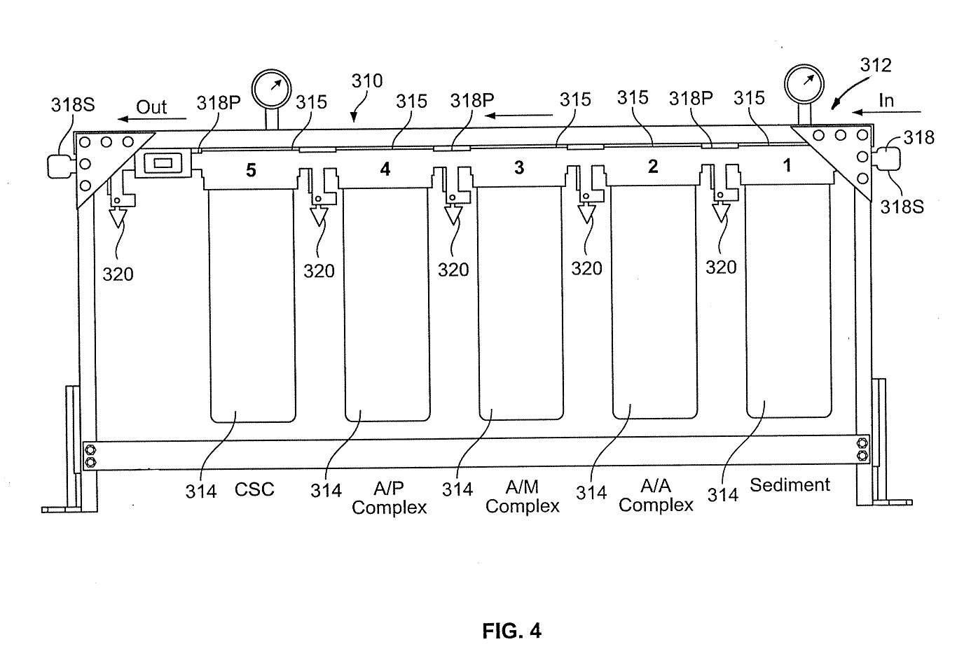

Referring now to FIG. 4, it will be seen that this embodiment of the present invention includes a five stage treatment unit 310. The five stage treatment unit 310 comprises a universal manifold 312 into which one or more media carrying vessels 314, similar to apparatus 210 (FIG. 3), can be attached. Attachment of the vessels 314 to the manifold 312 can be through screw type, bayonet or other type mounting means, all well known in the art.

The universal manifold 312 of the present embodiment includes a plurality of openings 315 for attachment of various treatment vessels 312, each having selected treatment media. The manifold 312 includes means 318 to direct water into the media such that the water can most efficiently pass through and be treated by the media. The means 318 for directing water includes at least one each of an inlet and outlet spigot 318s, or other water connection means, and appropriate pipe 318p, which can include any type of pipe or tubing typically used with water systems, such as PVC or other plastic pipe or tubing and copper or other metal pipes or tubing, and in particular traverses between the inlet and outlet spigots. Pipe 318s further connects the inlet and outlet spigots and the openings 315 through which the connection media are connected. FIG. 4A is a view of such a system from one side. It will be seen that manifold 312 can be supported simply by the use of structural stand members 313. In other embodiments, such systems can be attached to a surface for stability or can include casters or other mobility devices (not shown) to permit the device to be transported as needed.

It will be seen, in FIG.4, that the universal manifold 312 also includes at least one, and preferably a plurality, of taps 320 connected to pipes 318p so that water can be drained from the universal manifold at the tap location. It will be understood that taps 320 are useful in particular for testing water after passage through each treatment vessel 314 to determine the efficacy of the treatment, permitting informed changes to be made as needed. Manifold 312, in the present embodiment, and advantageously, can comprises water pressure metering devices 312p and a flow meter 324, all of which are useful to the management and testing of the efficacy of the device as a whole and each individual element thereof. It will be understood by persons having ordinary skill in the art that the various devices shown are merely examples of the plethora of devices that can be used to provide the described functions and that substitutions of devices that provide similar or like functions or data can be exchanged therefore, without departing from the novel scope of the present invention.

Further, the manifold 312 of the present invention is designed so that water is forced through each of the attached media vessels 314 in a series formation; that is the water progresses first through one treatment media vessel 314 before proceeding to the next media vessel until the desired water quality is achieved. Each vessel 314 can be referred to as a stage of treatment. Persons having ordinary skill in the art will understand that while a set number of treatment vessels 314 are shown and described in FIG. 4, any number of vessels 314 can be used, including more than one of on ore more of some vessels, without departing from the novel scope of the present invention, as needed to accomplish the desired treatment.

In FIG. 4, a manifold 312 having means for attachment of five treatment media vessels 314 stages is shown. It will be understood by persons having ordinary skill in the art that, in a similar manner, any other number of media stages can be used, as required by the level of water quality desired, without departing from the novel scope of the present invention.

In the present embodiment, the five stages include vessels 314 having media of the types described and explained in the present invention, as well as treatment media known to those having ordinary skill in water treatment arts to have similar or like treatment effect. In the present example, as shown in FIG. 4, a first vessel 314a (referring first to the right hand side of the manifold 312 as viewed in FIG. 4), is a filter that traps sediment and is preferably made primarily of polypropylene, which preferably has the ability to filter out particulates of a size range of about 1-5μ. The second vessel 314b can contain a sufficient supply of activated alumina complex, or A/A complex, which is a pH adjusted activated alumina having capability of adjusting the acidity of the treatment water and removing some of the fluoride or other ions present in the water that contacts the activated alumina.

The third vessel 314c can contain an alumina manganese complex or A/M complex (as described in Example 4, herein) or an alumina iron complex or A/I; followed by a fourth vessel 314d having an alumina/periodate complex or A/P complex (as described in Example 1, herein). It will be understood, from the discussion and particularly from the examples given herein, that each of the A/M, A/I and A/A complexes is useful in the removal of fluoride from water, whereas the A/P complex functions as a disinfectant. The A/I complex is typically used first as it is the least expensive followed by one or both of the A/I and A/M complexes, in series where both are used, that act as guard columns to finish the desired fluoride ion extraction. Manifold 312 can further comprise a fifth vessel 314e, containing coconut shell carbon (csc) media to adjust the taste and final quality of the water in the system. It will be understood by persons having ordinary skill in the art that the types and numbers of filtering and disinfecting media 340 used will be based on the initial condition of the water to be treated.

It will be understood that filtration, purification and other treatment media of the type described are available from a number of sources and manufacturers, many of which provide such media in forms suitable for attachment to a universal manifold 312 such as the one described. It will also be understood that raw media is also available and that such media can be placed into appropriate containers to recharge, clean and/or create appropriate filter media.

With respect to particulate and disinfection media, it is recommended that one or more of the anti-microbial and oxidative co-polymer media that are disclosed in allowed, co-pending U.S. patent application Ser. No. 10/023,022 be utilized. That application is incorporated, by reference, herein in its entirety. Such media provides anti-microbial disinfection without the use of chlorine. It will be understood, however, that use of other particulate and disinfection media can be utilized without departing from the novel scope of the present invention.

One contemplated apparatus such as that of FIG. 1 can be readily prepared by slurrying the particles in aseptic water that is free of contamination with fluoride ions. The slurry is added onto a flow-permitting support element such as a frit in a vertically oriented support vessel such as a column. The particles are permitted to settle under the force of gravity and can be packed more densely using vibration, tapping or the like. Once a desired height of particles is achieved, any excess liquid is removed as by vacuum, a second flow-permitting element such as another frit is inserted into the column above the particles and the cap is added.

To prepare another chromatographic column that can be used for a contemplated process, a portion of particles prepared as discussed above is slurried in aseptic, fluoride ion-free water and aliquots of that slurry are transferred under nitrogen pressure to a 10 cm long glass Bio-Rad® column (1.4 mm inside diameter) equipped with polypropylene fittings manufactured under the trademark “Cheminert” by Chromatronix, Inc., Berkeley, Calif. When the desired bed height is reached (corresponding to a bed volume of about 0.6 cm³), the particles are resettled by back-washing. The particles are then rinsed with several bed volumes of aseptic.

An apparatus shown in FIG. 2 can be prepared by adding a predetermined weight of dry particles to the cartridge 112 containing molded outlet 128 and support frit 122. The thus filled cartridge is vibrated in a vertical orientation to achieve a constant height for the particle bed, the upper porous support 118 is inserted, and the cap 124 containing molded fluid inlet 126 is placed onto the device.

In the contemplated process, contact between the particles and the contaminated aqueous fluoride-containing aqueous solution is maintained for a time period sufficient for the fluoride to be bound by the particles. That binding is usually quite rapid, with contact times of a few seconds to a few minutes typically being utilized. Much longer contact times such as a few hours can be utilized with no ill effect being observed.

The contact time is conveniently controlled by changing the flow rate through the column or flow-permissive container. The time that the solution is maintained in contact with the particles is the “solution residence time”.

The flow, temperature and pressure constraints of the process are dictated primarily by the limitations of the equipment utilized and the resin used in carrying out the invention. Ambient temperature and pressure are normally used.

It is to be understood that the solution having a further reduced fluoride concentration preferably has a concentration of fluoride ions that is less than a contaminating amount. Multiple contacting and maintenance steps can be utilized to achieve this desired result.

Another aspect of the invention contemplates modified particulate alumina containing meta-periodate ions substantially homogeneously sorbed throughout the particles. The particles are often referred to herein as A/P particles. The meta-periodate ions are present in an amount that can be up to the saturation point. However, preferably, the amount of meta-periodate ions is about 0.1 to about 0.15 molar in a gravity-settled volume of particles in deionized water. Sodium or potassium cations are the preferred counterions for the periodate ions. A lesser amount of meta-periodate anions can be present, but use of such an amount can be wasteful.

These A/P particles are useful as intermediates in forming the iron- or manganese-containing particles. These particles are also useful in removing manganese, iron, cobalt and mercury ions from aqueous compositions, which ions can be in a lower -ous or higher -ic oxidation state, such as ferrous or ferric, manganous or manganic, mercurous or mercuric of cobaltous or cobaltic ions. These A/P particles are also useful for removing harmful bacteria such as coliforms from water. In dried form, A/P particles can be used in an air filter.

### EXAMPLES

### Example 1

### Preparation of an Alumina/Meta-periodate (A/P) Complex

Thirty liters of deionized water was placed into a 12 gallon plastic graduated carboy (Nalgene Corp.). Next, 1-2 mL of concentrated sulfuric acid was added to the water. To the dilute acid solution, 800 grams of solid, sodium meta-periodate was added. The meta-periodate was dissolved by means of an overhead paddle stirrer. Solution was achieved in about 30 minutes at room temperature. The addition of sulfuric acid hastens the solution of meta-periodate salt but is not essential.

After solution was achieved, the stirrer was removed and solid, dry, activated alumina 28/48 mesh was scooped into the carboy with the aid of a wide-mouth funnel until the alumina level in the carboy was equal to the 30 liter mark (approximately 23 kg dry weight). The carboy cap was replaced and the carboy and contents, about 38 liters total reaction volume, was placed on its side and rolled periodically by means of a mechanical drum roller or by manually rolling the carboy across a flat surface such as a floor. Rolling was best accomplished in 2-3 minute intervals to ensure good mixing but avoiding conditions that promoted particle size reduction through milling.

After 4-5 rolling cycles, the carboy was placed upright and permitted to remain undisturbed overnight. At the end of this period, fines associated with the raw material alumina had settled leaving a clean, light yellow supernatant that tested negative for meta-periodate ion using starch/KI indicator solution. This indicated that all of the meta-periodate had bound to the alumina particles.

The meta-periodate-loaded alumina particles were removed from the carboy by pouring and sluicing by means of a water stream. Alumina/periodate particles were collected on a horizontal plate filter equipped with a window screen mat that permitted fines to pass through. The collected particles were washed with tap water until the effluent stream from the filter pot was relatively free of fines. Washes containing fines were collected in appropriately sized vessels or jugs allowing fines to settle prior to discarding the wash water mixed with reaction supernatant.

Alumina/periodate particles remaining on the filter screen are further de-watered by applying a water aspirator vacuum to the filter. Alumina/periodate (A/P) can be used directly at this point for preparation of alumina/iron complex or alumina/manganese complex. Alternatively, the de-watered alumina/periodate particles can be further dried (until free flowing) by loading in trays and air open- or oven-dried. The oxidation ability of dried A/P was retained over at least several months as ascertained by challenging with aqueous manganous (Mn II) or ferrous (Fe II) ions that result in characteristic colors formed within and upon the white A/P.

The scale of A/P production is easily modified by following the protocol of this example. For instance, batches of A/P 10-times larger than described here have been processed substituting a rotary cone vessel for the carboy and a centrifuge equipped with window screens for the horizontal plate filter. Additionally, activated alumina of different mesh size or shape; i.e., spherical, can be processed as in this example with essentially the same results.

### Example 2

### Preparation of Alumina/Iron (A/I) Particles

An iron oxide-alumina sorbent was prepared as follows. Ten liters of 0.125 M sodium meta-periodate (NaIO₄) were prepared in deionized water to which a few drops of sulfuric acid were added. The solution was placed into a 5 gallon plastic carboy. Alumina (Al₂O₃), 28-48 mesh, (Alcan AA400G) was scooped into the carboy until the solid reached the original 10 L volume, so that the container held about 12-14 L. The carboy was closed and rolled on a drum roller for a period of about 2 to 3 hours. Samples were taken from time to time from the supernatant and tested with starch iodide paper to test for free meta-periodate.

Once the supernatant was free of meta-periodate, the mixture was filtered under reduced pressure through a Buchner funnel using plastic window screen as the filter. The filter cake was rinsed with deionized water and then dewatered with the aspirator.

The filtered meta-periodate-treated alumina was added back to the carboy and 10 L of 0.125 M ferrous ammonium sulfate {Fe[(NH_{4)SO}₄]₂} were admixed with the meta-periodate-treated alumina. The carboy was closed and the contents mixed by rolling for about 12-16 hours (overnight). The surface of the alumina became dark brown in color from the white original color, and after the mixing period, the supernatant liquid tested negative for iron using a commercial test paper with a sensitivity of about 100 ppm. The iron oxide on alumina sorbent so prepared was filtered.

### Example 3

### Preparation of Alumina/Iron (A/I) Complex

Thirty liters of alumina/periodate (A/P) (a little more than 1 cubic foot) were placed in an empty, 12 gallon plastic carboy along with sufficient room temperature de-ionized water to just cover the A/P particles. Next, a solution of ferrous ammonium sulfate was added to the carboy prepared by dissolving 3.7 moles of the above salt (1.47 kg of monohydrate, mw 392) in about 2.5-3 gallons (about 10 liters) of room temperature de-ionized water.

The capped carboy's contents were mixed immediately by placing the carboy on its side and rolling on a flat surface or a mechanical drum roller. Mixing by rolling is continued at 1-2 minute intervals for 1-2 hours. After this time period, a test for ferrous ion remaining in the reaction supernatant is negative. Test strips for iron (II) from EM Science (Gibbstown, N.J. 08027) sensitive to 10 ppm are convenient for monitoring iron uptake by the A/P. The uptake of iron ion by the A/P particles was rapid and can be noted visually by the immediate change in color of the white A/P particles to a dark, rust-brown color of alumina/iron (A/I) particles upon adding and mixing the solution of ferrous ions to the A/P in the carboy.

The resulting A/I particles were filtered, washed and dried. Dried or wet A/I is stable indefinitely and does not bleed iron or aluminum when challenged with an aqueous flow in a pH value of about 5.5 to about 8.5.

### Example 4

### Preparation of Alumina/Manganese (A/M) Complex

Manganous sulfate tetrahydrate (MnSO₄.4H₂O; MWt 223; 836 g) was dissolved in approximately 10 liters of deionized water at room temperature, was added to 30 liters of A/P (Example 1) in a 12 gallon plastic carboy and mixed by periodic rolling in a manner. The resulting uniformly black particles of alumina/manganese (A/M) were filtered, washed and dried in an analogous manner to that described for the preparation of A/I given in Example 3. A/M particles are a dark-brown (black when wet) complex of alumina, an oxide of iodine and an oxide of manganese, probably Mn⁺⁴. A/M was found to be stable indefinitely.

### Example 5

### Comparison of A/I Particles to Particles Prepared as in WO 99/50182

An iron oxide-alumina composite described in WO 99/50182 is commercially available (Alcan Aluminum Co., Brockville, Ontario, Canada) as AAFS50. That material is further described by its manufacturer as alumina containing 6.0 percent Fe₂O₃ (about 4.2 percent Fe) by weight. In contrast, A/I particles of this invention contain a calculated amount of about 1.2 percent by weight of Fe.

Visually, A/I appears to have a darker, more intense and uniform rust color compared to AAFS50 particles that are speckled, non-uniform, and much lighter in color. AAFS50 particles subjected to crushing (mortar and pestle) reveal a white core within the particle indicating a coating of Fe₂O₃ on the exterior. Similar crushing of A/I particles reveal a uniform, dark rust color throughout the particles.

It was surprising that meta-periodate bound to alumina serves both as an oxidant and complexing agent to the challenging ferrous ions. A/I prepared by the present method when re-challenged with fresh ferrous ammonium sulfate solution slowly liberates free, elemental iodine (I₂) as evidenced by iodine crystals forming and purple color in the vapor phase. A positive starch test was also observed.

A/I particles prepared by this invention thus have residual meta-periodate ion (or similar oxidant) in some form as an integral component. A/I particles are a substantially homogeneous composition of iron in an unknown bonding state, an oxide of iodine and alumina. WO 99/50182 describes a composite of iron oxide carried as a coating on alumina.

### Example 6

### Fluoride Adsorption Capacity of Modified Alumina Particles

In this example, three types of particles were examined for their ability to reduce the fluoride concentration of an aqueous solution (10-12 mg/l F⁻) at two different pH levels, lower pH 6.48-6.52 and higher pH 8.2-8.6. The modified alumina particles of the present invention, alumina/iron (A/I) and alumina/manganese (A/M), were assayed along with a commercially available activated aluminum. However, the activated alumina was tested at the pH 6.8 to 7.4 which is a limitation with this medium. An adsorption bed (20 ml) was achieved by slurrying the A/I, A/M, or alumina into a column configured with a down flow over and through the particle media bed and up through a return tube. The recommended flow rate to achieve sufficient contact and grafting to particle surfaces was equivalent to one bed volume per minute (20 ml per min.) for the A/I and A/M particles but a flow rate 5 times slower had to be used for the activated alumina bed (an additional limitation). The Empty Bed Contact Time [EBCT] was 1.0 to 1.5 minutes for A/I and A/M and 5 to 7 minutes for the activated aluminum (another limitation).

Fluoride Adsorption Capacity of Modified Alumina
Particles pH 6.48-6.52

| Liters of | | |
|---|---|---|
| aqueous | | |
| solution | Sample A/I CPLX 2002 | Sample A/M CPLX 2001 |
| passed | concentration of | concentration of |
| through | fluoride in | fluoride in |
| column | effluent (mg/l) | effluent (mg/l) |
| 1 | 0.07 | 0.00 |
| 2 | 0.18 | 0.00 |
| 3 | 0.84 | 0.39 |
| 4 | 2.60 | 0.36 |
| 5 | 4.50 | 0.10 |
| 6 | 5.45 | 0.20 |
| 7 | 6.10 | 0.15 |
| 8 | 6.90 | 0.43 |
| 9 | 7.80 | 1.28 |
| 10 | 9.50 | 2.74 |

Fluoride Adsorption Capacity of Modified Alumina
Particles pH 8.2-8.6

| Liters of | | |
|---|---|---|
| aqueous | | |
| solution | Sample A/I CPLX 2002 | Sample A/M CPLX 2001 |
| passed | concentration of | concentration of |
| through | fluoride in | fluoride in |
| column | effluent (mg/l) | effluent (mg/l) |
| 1 | 0.11 | 0.21 |
| 2 | 0.09 | 0.04 |
| 3 | 2.55 | 0.00 |
| 4 | 6.55 | 0.28 |
| 5 | 8.40 | 0.34 |
| 6 | 9.20 | 0.51 |
| 7 | 9.98 | 0.50 |
| 8 | 10.00 | 1.90 |
| 9 | 10.00 | 2.68 |
| 10 | 11.00 | 4.30 |

Because the pH value, the flow rate and the re different in the activated alumina bed, the are listed here instead of on the tables For activated alumina, only 1,500 ml of the fluoride solution was passed through the before the 20 ml bed was exhausted. In other words, the bed size of activated alumina was 5 to 7 times larger than that of either A/I or A/M, yet the total capacity of an activated alumina bed was a small fraction of either of the smaller beds of Alumina/Iron Complex or Alumina/Manganese Complex.

Each of the patents and articles cited herein is incorporated by reference. The use of the article “a” or “an” is intended to include one or more.

The foregoing description and the examples are intended as illustrative and are not to be taken as limiting. Still other variations within the spirit and scope of this invention are possible and will readily present themselves to those skilled in the art.

What is claimed:

1. A process for removing fluoride ions from a contaminated aqueous solution that comprises:
a) contacting a fluoride ion-contaminated aqueous solution with modified alumina particles, wherein said modified alumina particles contain iron or manganese or both sorbed substantially homogeneously distributed throughout;
b) maintaining said contact for a time period sufficient for fluoride ions to be sorbed by the modified alumina particles to form particles containing fluoride ions and an aqueous solution having a reduced fluoride ion concentration; and
c) separating the modified alumina particles containing fluoride ions from the aqueous solution having a reduced fluoride ion concentration.

2. The process according to claim 1 wherein said modified alumina particles comprise iron substantially homogeneously sorbed throughout the particles and wherein said iron is present in an amount of about 0.10 to about 0.15 molar in a gravity-settled volume of particles in deionized water.

3. The process according to claim 1 wherein said modified alumina particles comprise manganese substantially homogeneously sorbed throughout the particles and wherein said manganese is present in an amount of about 0.05 to about 0.075 molar in a gravity-settled volume of particles in deionized water.

4. The process according to claim 1 wherein the pH value of the aqueous solution about 6 to about 9.

5. The process according to claim 1 wherein the pH value of the aqueous solution is about 6.5 to about 8.6.

6. A process for removing fluoride ions from a contaminated aqueous solution that comprises:
a) contacting a fluoride ion-contaminated aqueous solution containing with a portion of modified alumina particles, wherein said modified alumina particles contain iron or manganese or both sorbed substantially homogeneously distributed throughout and wherein said portions of particles in the sequence are comprised of the same type of particles (aⁿ), one or more different particles (aⁿ+bⁿ), or a mixture thereof (a+b)ⁿ;
b) maintaining said contact for a time period sufficient for fluoride ions to be sorbed by the modified alumina particles to form particles containing fluoride ions and an aqueous solution having a reduced fluoride ion concentration;
c) separating the modified alumina particles containing fluoride ions from the aqueous solution having a reduced fluoride ion concentration;
d) contacting said separated aqueous solution having reduced fluoride ion concentration with another portion of modified alumina particles;
e) maintaining said contact for a time period sufficient for fluoride ions to be sorbed by the modified alumina particles to form particles containing fluoride ions and an aqueous solution having a further reduced fluoride ion concentration; and
f) separating the modified alumina particles containing fluoride ions from the aqueous solution having a further reduced fluoride ion concentration.

7. The process according to claim 6 wherein the modified particles are alumina-iron.

8. The process according to claim 6 wherein the modified alumina particles are alumina-manganese.

9. The process according to claim 6 wherein the modified alumina particles are a heterogeneous mixture of alumina-iron and alumina-manganese particles.

10. A process for removing fluoride ions from a fluoride ion-contaminated water supply that comprises the steps of;
a) contacting a fluoride ion-contaminated aqueous solution having pH value of about 6 to about 9 with modified alumina particles, said modified alumina particles containing iron or manganese or both sorbed substantially homogeneously distributed throughout in an amount of about 0.05 to about 0.15 molar as measured in a gravity-settled volume of particles in deionized water, said particles also containing an oxidized iodine species and being substantially free of molecular iodine;
b) maintaining said contact for a time period sufficient for fluoride ions present to be sorbed by the particles to form fluoride ion-containing particles and an aqueous solution having a lessened amount of fluoride ions; and
c) separating said fluoride ion-containing particles from said aqueous solution having a lessened amount of fluoride ions.

11. The process of claim 10 wherein the pH value of the aqueous solution about 6.5 to about 8.6.

12. The process according to claim 10 wherein the aqueous solution has been pre-filtered to remove substantially all solid material.

13. An apparatus for removing fluoride from a fluoride ion-contaminated aqueous solution that comprises a vessel having an inlet, an outlet, and a modified alumina complex in a modified-alumina-complex-containing region wherein the complex is supported and contained within the modified-alumina-complex-containing region.

14. The apparatus according to claim 13 wherein said vessel includes a first flow-permitting support positioned between the outlet and modified-alumina-complex-containing region.

15. The apparatus according to claim 13 wherein said vessel includes a second flow-permitting support positioned between the inlet and modified-alumina-complex-containing region.

16. The separation apparatus according to claim 13 wherein said inlet and outlet are separated from each other.

17. The separation apparatus according to claim 13 wherein said the inlet and outlet are at opposite ends of the apparatus.
